(19) United States
(12) Patent Application Publication
(10) Pub. No.: US 2002/0113347 A1
(43) Pub. Date: Aug. 22, 2002

(54) Adjustable shock absorber

(76) Inventor: Lorin Robbins, Tochigiken Nasugun (JP)

Correspondence Address: BRIAN F SWIENTON, OPPENHEIMER WOLFF & DONNELLY LLP, 840 NEWPORT CENTER DRIVE, SUITE 700, NEWPORT BEACH, CA, 92660, US

(21) Appl. No.: 09/566,501

(22) Filed: May 8, 2000

(51) Int. Cl. F16F 9/43

(52) U.S. Cl. 267/64.28; 280/124.16

(57) ABSTRACT

Improved adjustable shock absorbers comprising a cylinder, a piston movable within said cylinder, a source of hydraulic or pneumatic fluid, a pump, means connecting said source to supply fluid through said pump to said cylinder, valve means operable from the driver's seat for regulating the flow of fluid from said source to said cylinder, damper means located within said cylinder for controlling oscillation of said piston, said cylinder and piston being connected between the axle and frame of said vehicle to regulate the ground clearance and ride stiffness of said vehicle.

### RELATED CASES

This invention is described in my copending Provisional Patent Application Ser. No, 60/131,700 filed Apr. 30, 1999 and now expired.

### FIELD OF INVENTION

This invention relates to automobiles and is particularly directed to improved shock absorbers which are adjustable to enable the driver to adjust the ground clearance of the vehicle to obtain a smoother ride or avoid obstructions.

### PRIOR ART

Shock absorbers have long been used in automotive vehicles and the like to cushion the driver and passengers against the jolting movement of the vehicle as it travels over stones, ruts and other minor obstructions in its path. More recently adjustable shock absorbers have been proposed which enable the driver to inflate or deflate the shock strut prior to use to alter the ground clearance of the vehicle when the driver intends to drive off-road or in other rough conditions. Unfortunately, the prior art adjustable shock absorbers must be adjusted prior to use and cannot be adjusted while driving. Thus, the driver must know, in advance, that he is going to encounter rough driving conditions. However, in actual driving conditions, a driver may come upon a detour which requires him to traverse rough terrain or he may see some area adjacent the road which he would like to explore and would like to adjust the shock absorbers on-site to control the ride stiffness and ground clearance of the vehicle. With fixed shock absorbers or the prior art pre-adjustable shock absorbers, this cannot be accomplished. Thus, none of the prior art shock absorbers have been entirely satisfactory.

### BRIEF SUMMARY AND OBJECTS OF INVENTION

These disadvantages of the prior art are overcome with the present invention and improved shock absorbers are provided which can be adjusted at any time, prior to or during driving, to vary the ride stiffness and ground clearance of the vehicle.

The advantages of the present invention are preferably attained by providing improved adjustable shock absorbers comprising a cylinder, a piston movable within said cylinder, a source of hydraulic or pneumatic fluid, a pump, means connecting said source to supply fluid through said pump to said cylinder, valve means operable from the driver's seat for regulating the flow of fluid from said source to said cylinder, damper means located within said cylinder for controlling oscillation of said piston, said cylinder and piston being connected between the axle and frame of said vehicle to regulate the ground clearance and ride stiffness of said vehicle.

Accordingly, it is an object of the present invention to provide improved shock absorbers for vehicles.

Another object of the present invention is to provide improved vehicle shock absorbers which are adjustable to regulate the ride stiffness and ground clearance of the vehicle.

An additional object of the present invention is to provide improved vehicle shock absorbers which are adjustable prior to and during driving to regulate the ride stiffness and ground clearance of the vehicle.

A further object of the present invention is to provide improved vehicle shock absorbers which which are adjustable from the driver's seat to regulate the ride stiffness and ground clearance of the vehicle.

Another object of the present invention is to provide improved vehicle shock absorbers which are adjustable from the driver's seat, prior to and during driving, to regulate the ride stiffness and ground clearance of the vehicle.

A specific object of the present invention is to provide improved adjustable shock absorbers comprising a cylinder, a piston movable within said cylinder, a source of hydraulic or pneumatic fluid, a pump, means connecting said source to supply fluid through said pump to said cylinder, valve means operable from the driver's seat for regulating the flow of fluid from said source to said cylinder, damper means located within said cylinder for controlling oscillation of said piston, said cylinder and piston being connected between the axle and frame of said vehicle to regulate the ground clearance and ride stiffness of said vehicle.

These and other objects and features of the present invention will be apparent from the following detailed description, taken with reference to the figures of the accompanying drawing.

### BRIEF DESCRIPTION OF THE DRAWING

FIG. 1 is a diagrammatic representation showing a vehicle embodying the adjustable shock absorbers of the present invention; and

FIG. 2 is a vertical section through the cylinder of the adjustable shock absorber of FIG. 1.

### DETAILED DESCRIPTION OF THE INVENTION

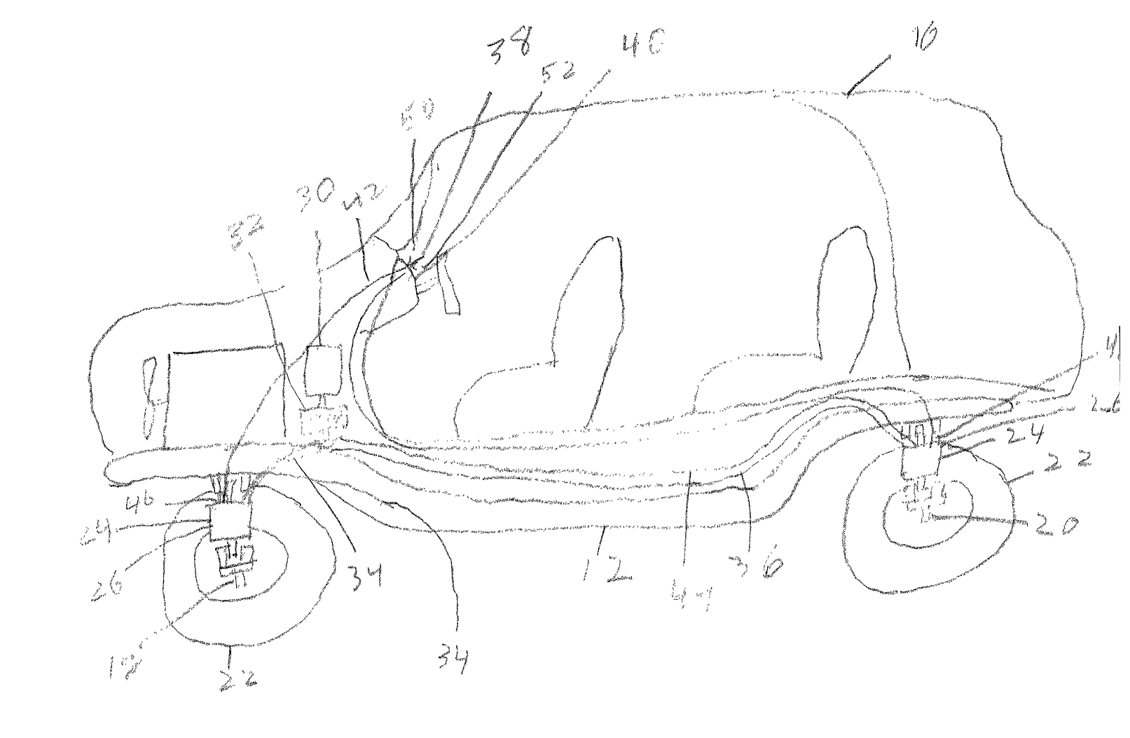

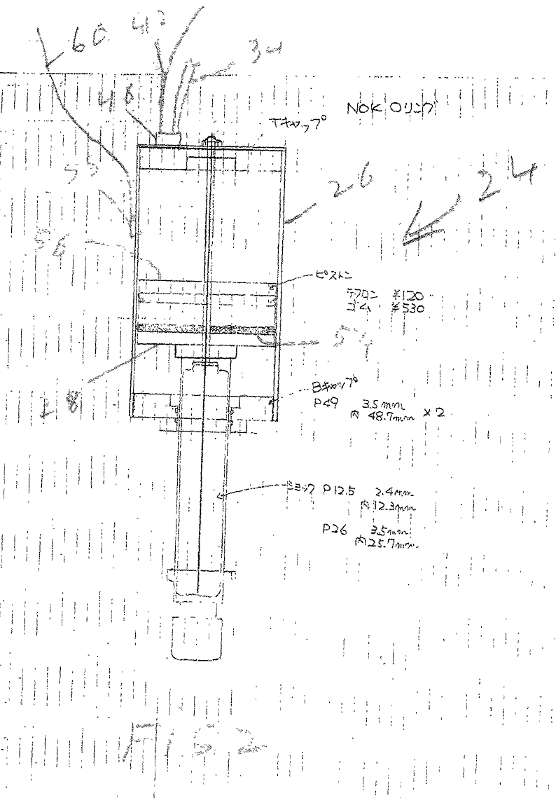

In that form of the present invention chosen for purposes of illustration in the drawing, FIG. 1 shows a vehicle, indicated generally at 10, having a frame 12 which is supported on axles 18 and 20 which, in turn, are supported by wheels 22. In accordance with the present invention, shock absorbers 24 are interposed between the frame 12 and the axles 18 and 20, replacing the conventional springs, to resiliently support the vehicle 10 adjacent each of the wheels 22, and serve to smooth out the vibrations which would be caused by such things as the wheels 22 passing over stones, ruts, etc. on the ground. As best seen in FIG. 2, the shock absorbers 24 each comprise a fluid cylinder 26 having a piston 28 slideably positioned within the cylinder 26. Fluid for moving the pistons 28 is supplied from a fluid source 30 through pump 32 and hoses 34 and 36. A switch 38 is mounted on the driver's dashboard 40 and is connected by wires 42 and 44 to electrically controlled valves 46 and 48 on the fluid cylinders 26 of the shock absorbers 24. Switch 38 movable between an “UP” position, seen in dotted lines at 50, which opens the valves 46 and 48 to allow pump 32 to deliver additional fluid into the fluid cylinders 26, to stiffen the ride of the vehicle 10 or to lift the frame 12 of the vehicle 10 to increase the ground clearance of the vehicle 10, and a “DOWN” position, seen in dotted lines at 52, which causes valves 46 and 48 to allow fluid to flow from the fluid cylinders 26 through hoses 34 and 36 to return to the fluid source 30 and, hence, to soften the ride of the vehicle 10 or to lower the frame 12 to decrease the ground clearance of the vehicle 10. As best seen in FIG. 2, the piston 28 carries suitable O-rings 54 to prevent fluid leakage about the piston 28. A damper member 56 is freely movable within the cylinder 26 between the piston 28 and the closed end 58 of the cylinder 26 and serves to dampen oscillation of the piston 28 which might otherwise occur. If desired, sensors may be provided in the shock absorbers 24 to sense the position of the piston 28 within the fluid cylinder 26 and to supply this information, via wires 60, to suitable display means 62, located on the dashboard 40 of the vehicle 10 to provide the driver with a visual indication of the position of the piston 28 and, hence, of the stiffness of the ride or the height of the frame 12 above the ground.

In use, the driver normally drives the vehicle 10 in the usual manner. However, if the driver wishes to harden the ride stiffness or to increase the height of the frame 12 above the ground, the driver moves switch 38 to the “UP” position 50 to activate valves 46 and 48 to allow pump 32 to deliver fluid from fluid source 30 through hoses 34 and 36 into the shock absorbers 24 to drive pistons 28 downward and, hence, to increase the distance between the frame 12 and the ground. Subsequently, if the driver wishes to soften the ride stiffness or to decrease the ground clearance, the driver moves switch to the “DOWN” position 52, which opens valves 46 and 48 to allow fluid from the shock absorbers 24 to return through hoses 34 and 36 to the fluid source 30.

Obviously, numerous variations and modifications can be made without departing from the spirit of the present invention. Therefore, it should be clearly understood that the form of the present invention described above and shown in the figures of the accompanying drawing are illustrative only and are not intended to limit the scope of the present invention.

What is claimed is:

1. Adjustable shock absorbers comprising:
a fluid cylinder,
a piston movable within said cylinder,
a source of fluid,
a pump,
means connecting said source to supply fluid through said pump to said cylinder,
valve means operable from the driver's seat for regulating the flow of fluid from said source to said cylinder.

2. The shock absorber of claim 1 wherein:
said cylinder and piston are connected between the axle and frame of said vehicle to regulate the ground clearance and ride stiffness of said vehicle.

3. The shock absorber of claim 1 further comprising:
damper means located within said cylinder for controlling oscillation of said piston.

4. The shock absorber of claim 1 further comprising:
sensors located in the fluid cylinders to sense the position of the pistons within the fluid cylinder and to supply this information, via wires, to display means located on the dashboard of the vehicle to provide the driver with a visual indication of the position of the piston and, hence, of the stiffness of the ride or the height of the frame above the ground.

5. The shock absorber of claim 1 wherein:
said shock absorber replaces a conventional spring to resiliently support said vahicle.
